(19) United States
(12) Patent Application Publication
(10) Pub. No.: US 2015/0286758 A1
(43) Pub. Date: Oct. 8, 2015

(54) CIRCUIT SIMULATION DEVICE, CIRCUIT SIMULATION METHOD, AND PROGRAM

(71) Applicant: NEC Corporation, Minato-ku, Tokyo (JP)

(72) Inventors: Masashi Kawakami, Tokyo (JP); Manabu Kusumoto, Minato-ku (JP); Masashi Ogawa, Minato-ku (JP); Hisashi Ishida, Minato-ku (JP)

(73) Assignee: NEC Corporation, Tokyo (JP)

(21) Appl. No.: 14/434,458

(22) PCT Filed: Jun. 25, 2013
(86) PCT No.: PCT/JP2013/067352

§ 371 Date: Apr. 9, 2015

(30) Foreign Application Priority Data
Oct. 16, 2012 (JP) 2012-229301

(51) Int. Cl. G06F 17/50

(52) U.S. Cl. CPC G06F 17/5036

(57) ABSTRACT

Provided is a circuit analysis system using a circuit simulation model generation method such that, in a circuit including an LSI, signal characteristics and power supply characteristics can be analyzed accurately and in a short time. Provided is a circuit simulation device characterized by having: an input device (21) that inputs I-V characteristics, V-T characteristics, operating frequency, and operation pattern of a semiconductor integrated device; a simplified LSI model generation unit (22) that generates a simplified LSI model of the semiconductor integrated device on the basis of the contents of input from the input device (21); and an operating unit (25) that analyzes a circuit including the simplified LSI model.

### TECHNICAL FIELD

The present invention relates to a circuit simulation device, a circuit simulation method, and a program.

### BACKGROUND ART

Techniques as described below have been proposed for improving analytical accuracy and convenience of SI (Signal Integrity) analysis using behavioral models.

The technique described in PTL 1 prevents a user from remaining unnoticed of erroneous analysis with low accuracy by monitoring the operation condition of a behavioral model upon analysis execution, calculating analytical accuracy based on accuracy information added to the model or accuracy information calculated from element characteristics, and, if the analytical accuracy is low, notifying the user of the effect thereof and a recommended behavioral model generation condition, then, presenting the recommended behavioral model generation condition that satisfies the required analytical accuracy or automatically generating the recommended behavioral model.

PTL 2 describes a calibration method of Input/output Buffer Information Specification (IBIS) models. IBIS models provided by Large-Scale Integration (LSI) vendors describe only electrical characteristics of at most three specific power supply voltages. However, the operation of an LSI is sometimes compensated by power supply voltages different from the specific power supply voltages. In such a case, there is a problem where the SI analysis using the IBIS shows poor accuracy because the power supply voltage is different. PTL 2 proposes calibrated IBIS data that is calibrated to correspond to arbitrary desired power supply voltages that are different from the specific power supply voltages, which can be generated in a short time and with high accuracy.

### CITATION LIST

### Patent Literature

[PTL 1] Publication of Japanese Patent No. 4524322

[PTL 2] Publication of Japanese Patent No. 4553852

### SUMMARY OF INVENTION

### Technical Problem

With the recent increase in speed and lowering of the voltage of switching with regard to LSIs as a background, the influence of power supply voltage fluctuation is becoming relatively significant. FIG. 1 shows this problem.

For example, power supply for a driver LSI 12 and a receiver LSI 13 sufficient to operate is not provided due to high frequency noise propagated between a power plane 10 and a GND plane 11, whereby the operation (a driver side power supply voltage waveform 16, a receiver side power supply voltage waveform 17) becomes unstable. Further, due to the power supply voltage fluctuation of the power supply, the power supply noise is superimposed on a signal line 14 through the driver LSI 12, which also affects SI. Note that, in signal waveforms 15, the solid line indicates an ideal power supply, while the dot line indicates a signal that is deteriorated by high frequency noise superimposed thereon upon receiving the power supply due to the power supply voltage fluctuation.

To recognize such a problem at the designing stage, coupled analysis of SI analysis and PI analysis is required. However, there is a problem where the IBIS models that are the most commonly available of behavioral models and the techniques of PTL 1 and PTL 2 are specialized for SI analysis without consideration to be used in PI (Power Integrity) analysis. Particularly, as current circuit simulators operate IBIS models in accordance with an I-V characteristics and V-T characteristics table, the simulators show poor accuracy in PI analysis.

Although IBIS version 5.0 and later versions are compatible with PI analysis, they are provided only in limited high-end LSIs, as they require a lot of man-hours for creating a model and are delayed in popularization.

The present invention is made in consideration of the problems embedded in conventional techniques as described above, and aims to provide a circuit analysis system using a circuit simulation model generation method that can analyze signal characteristics and power supply characteristics in circuits including LSIs with high accuracy.

### Solution to Problem

According to the present invention, provided is a circuit simulation device that includes: an input device that inputs I-V characteristics, V-T characteristics, an operating frequency, and an operation pattern of a semiconductor integrated device; simplified LSI model generation means that generates a simplified LSI model of the semiconductor integrated device on the basis of contents of input from the input device; and operating means that analyzes a circuit that includes the simplified LSI model.

Further, according to the present invention, provided is a circuit simulation method that executes, by a computer; an input step that inputs I-V characteristics, V-T characteristics, an operating frequency and an operation pattern of a semiconductor integrated device; a simplified LSI model generation step that generates a simplified LSI model of the semiconductor integrated device on the basis of the contents of input in the input step; and an operating step that analyzes a circuit that includes the simplified LSI model.

Further, according to the present invention, provided is a program that causes a computer to function as: input means that inputs I-V characteristics, V-T characteristics, an operating frequency and an operation pattern of a semiconductor integrated device; simplified LSI model generation means that generates a simplified LSI model of the semiconductor integrated device on the basis of contents of input from the input means; and operating means that analyzes a circuit that includes the simplified LSI model.

### ADVANTAGEOUS EFFECT OF INVENTION

According to the present invention, signal characteristics and power supply characteristics of circuits including LSIs can be analyzed in a short time and with high accuracy.

### BRIEF DESCRIPTION OF DRAWINGS

The above-described objective, and other objectives, features, and advantages of the present invention will be further clarified with the following preferred embodiments and appended drawings.

FIG. 1 is a diagram for illustrating a background of the embodiment;

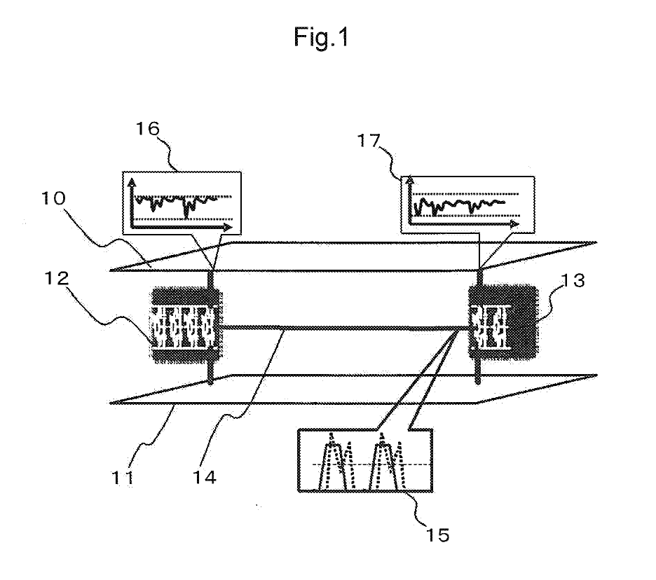

FIG. 2 is a diagram illustrating an example of a functional block view of a circuit simulation device of the embodiment;

FIG. 3 is a diagram illustrating a detailed configuration of a simplified LSI model generation unit 22 of the embodiment;

FIG. 4 is a flowchart for illustrating an example of a flow of processing of a circuit simulation method of the embodiment;

FIG. 5 is a diagram illustrating an example of a cross section structure of board wiring;

FIG. 6 is a flowchart for illustrating an example of a flow of processing of a circuit simulation method of the embodiment;

FIG. 7 is a diagram illustrating an example of an equivalent circuit model per unit length that is obtained by solver processing;

FIG. 8 is a diagram illustrating an example of a variable resistance generated by the embodiment;

FIG. 9 is an example of a power supply waveform as a result of a simulation according to the embodiment;

FIG. 10 is an example of a signal waveform as a result of a simulation according to the embodiment; and

FIG. 11 is a diagram illustrating an example of a Print Circuit Board (PCB) including a signal transmission path to which an LSI and other components are connected.

### DESCRIPTION OF EMBODIMENTS

The following will describe the optimum embodiment of the present invention with reference to the drawings.

Note that the system and device of the embodiment are realized by an arbitrary combination of hardware and software, primarily by a CPU, a memory, a program loaded into the memory (including a program previously stored in a memory as a factory default, and a program downloaded from a recording medium such as a CD and from a server on the Internet and the like), a storage unit such as a hard disk that stores the program, and a network connection interface of an arbitrary computer. It should be understood by those skilled in the art that there are a variety of variations for the implementation method and device.

Further, the functional block views used in the description of the embodiment indicate blocks of functional units rather than a structure of hardware units. In the drawings, each system and device is described as being implemented by one instrument, although the implementation means is not limited to this. More specifically, the configuration may be physically separated or logically separated.

The circuit simulation device of the embodiment has: an input device that inputs I-V characteristics, V-T characteristics, an operating frequency, and an operation pattern of a semiconductor integrated device; a simplified LSI model generation unit that generates a simplified LSI model of the semiconductor integrated device on the basis of the contents of input from the input device; and an operating unit that analyzes a circuit including the simplified LSI model.

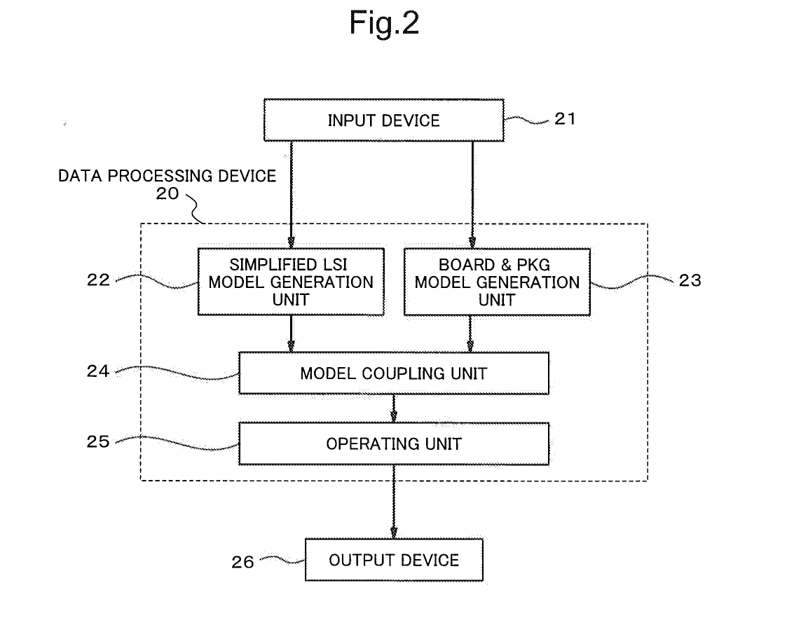

FIG. 2 is a diagram illustrating an example of a functional block view of a circuit simulation device of the embodiment.

In the embodiment, an input device 21 inputs information relating to the semiconductor integrated device as an object of analysis, in particular, input information that is required for analysis of behavioral models including I-V characteristics, V-T characteristics, an operating frequency, and an operation pattern, to a data processing device 20. For example, the input device 21 may accept input of information as described above from a user, then, the input device 21 may input the received information to the data processing device 20, or, the input device 21 may acquire information as described above from a storage device that stores such information and input the acquired information to the data processing device 20.

Next, a simplified LSI model generation unit 22 provided in the data processing device 20 creates a simplified LSI model using the information input from the input device 21.

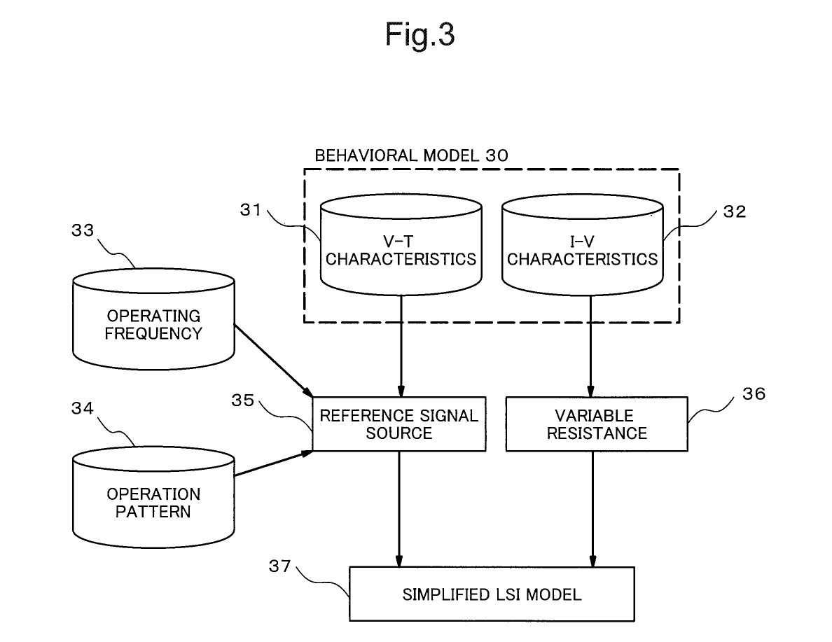

FIG. 3 specifically describes the process performed by the simplified LSI model generation unit 22.

A reference signal source 35 is generated using V-T characteristics 31, an operating frequency 33, and an operation pattern 34 of a behavioral model 30 which are input from the input device 21. Further, a variable resistance 36 is generated using I-V characteristics 32 of the behavioral model 30 input from the input device 21. Then, a simplified LSI model 37 is generated using the reference signal source 35 and the variable resistance 36. The details will be described later herein.

Returning to FIG. 2, a board & PKG model generation unit 23 provided within the data processing device 20 generates an equivalent circuit of the board and package on which the semiconductor integrated device as an analysis object is to be mounted.

Next, a model coupling unit 24 provided within the data processing device 20 generates a circuit simulation model by coupling the simplified LSI model generated by the simplified LSI model generation unit 22 and the equivalent circuit of the board and package which is generated by the board & PKG model generation unit 23.

Next, an operating unit 25 provided in the data processing device 20 performs analysis based on the circuit simulation model generated by the model coupling unit 24.

Next, the analysis result by the operating unit 25 is output to an output device 26, thereby completing the processing of the system.

The following will describe the circuit simulation method of the circuit simulation device illustrated in FIG. 2.

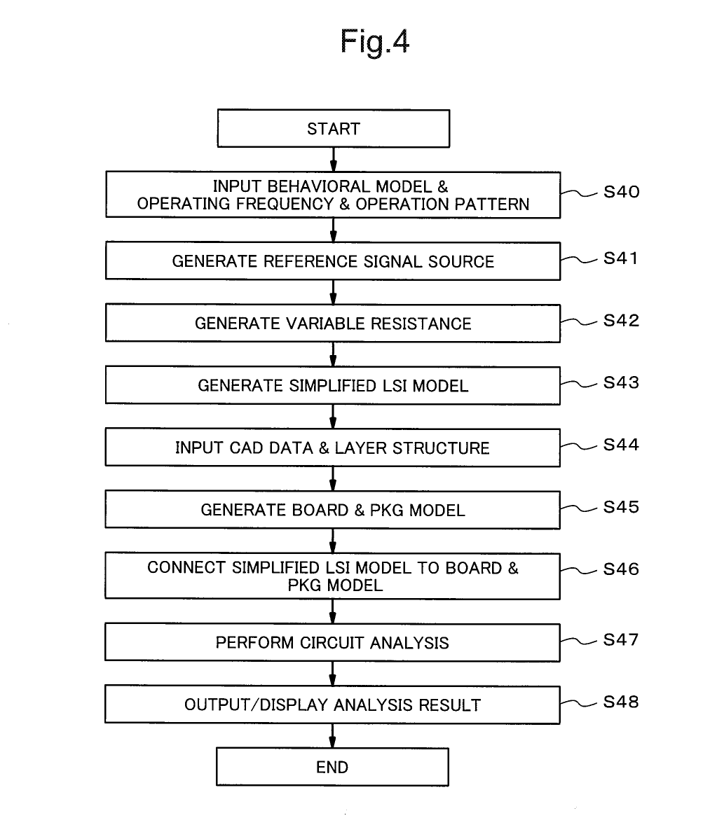

FIG. 4 is a flowchart for illustrating an example of a circuit simulation method of the circuit simulation device illustrated in FIG. 2.

First, the input device 21 illustrated in FIG. 2 inputs the behavioral model 30 including the V-T characteristics 31 and the I-V characteristics 32, the operating frequency 33, and the operation pattern 34 to the simplified LSI model generation unit 22 (S40). The operation pattern 34 may be a signal waveform derived from a logic simulation, operation that cyclically repeats High and Low, random operation, or the like.

Then, the simplified LSI model generation unit 22 generates a reference signal source using the V-T characteristics 31, the operating frequency 33, and the operation pattern 34 (S41). For example, a table of time and signal for each bit is first generated from the operating frequency 33 in relation to the operation pattern 34. Then, rising and falling electrical characteristics are inserted based on the V-T characteristics 31 to the portions where a signal state is transiting. This allows generation of a reference signal source that can control signals in consideration of the rising and falling characteristics of signals.

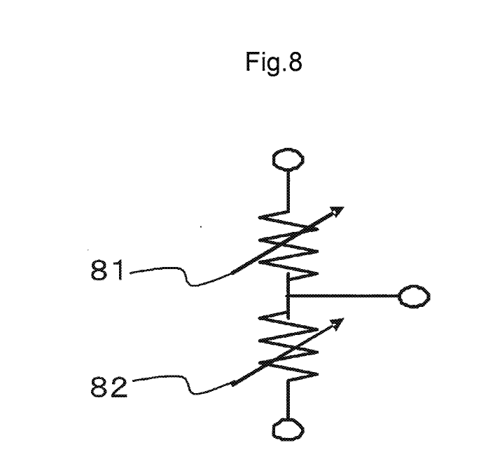

Further, the simplified LSI model generation unit 22 generates a variable resistance using the I-V characteristics 32 (S42). FIG. 8 illustrates an example of a variable resistance that is generated by the simplified LSI model generation unit 22. For example, the I-V characteristics 32 of the behavioral model 30 are electrical characteristics that describe a relationship of voltage and current applied between the power supply and signals. By applying the Ohm's law R=V/I to the I-V characteristics 32, the values of resistance with respect to the voltage applied between the power supply and signals can be derived. A pull-up variable resistance 81 is generated based on the relationship of resistance with respect to the voltage applied between the power supply and signals. A pull-down variable resistance 82 is also generated by performing the same processing for between signals and the GND. A variable resistance is generated by connecting the pull-up variable resistance 81 and the pull-down variable resistance 82 in series.

Note that the processing order of S41 and S42 is not limited to the one illustrated in FIG. 4, thus, for example, the order may be reversed.

Next, the simplified LSI model generation unit 22 generates a simplified LSI model (S43). In particular, the variable resistance generated at S42 is connected so as to be controlled by the reference signal source generated at S41.

Next, the input device 21 inputs CAD data & a layer structure to the board & PKG model generation unit 23 (S44). Note that the processing order is not necessarily limited to the one illustrated in FIG. 4 as long as S44 is performed before S45.

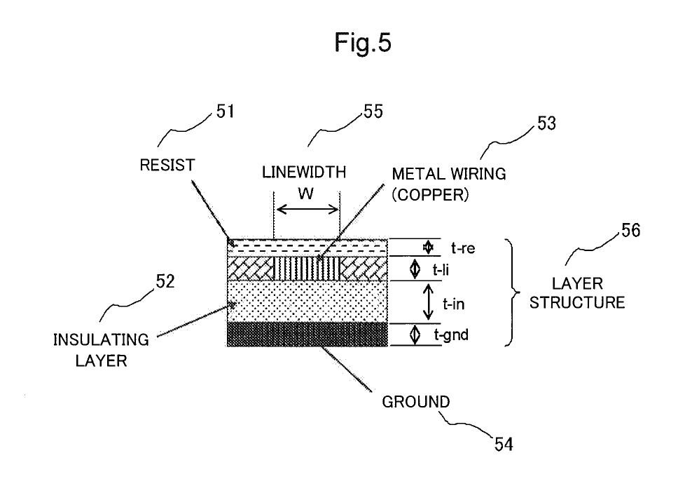

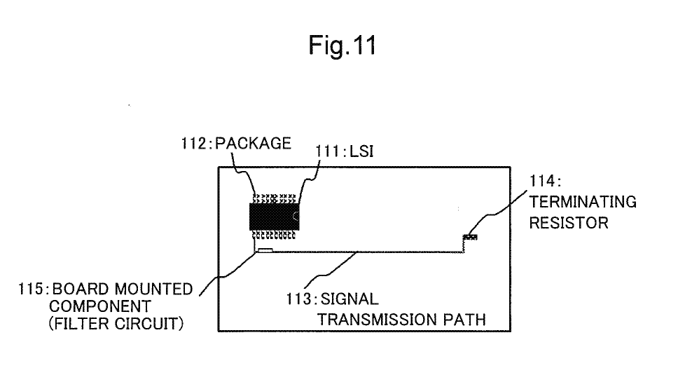

The following will describe the CAD data & layer structure to be input. A print circuit board on which an LSI and other components are mounted as illustrated in FIG. 11 is exemplified. The CAD data & layer structure is a collective term of values relating to structural and material characteristics, such as a linewidth 55, electrical conductivity among wiring and electrical characteristic information of metal wiring 53, and relative permittivity εr and dielectric tangent tan δ among electrical characteristic information of a resist 51 and electrical characteristic information of an insulating layer 52, in the wiring structure of a board as exemplified in FIG. 5, in addition to the layout information of a signal transmission path 113.

The wiring length that is an important parameter of the signal transmission path 113 can be easily extracted from wiring information in the CAD system for designing the print circuit board. While FIG. 5 illustrates a configuration (a cross section view) of a board that has a wiring pattern of a microstrip line structure, here, it is possible to perform processing in which a material name, such as copper, may be input instead of electrical conductivity and replaced with electrical conductivity in the internal database. As such, parameters for each wiring of respective components that are required for obtaining an electrically equivalent circuit of the power supply wiring of the board are input.

Next, the board & PKG model generation unit 23 generates a board & PKG model using the CAD data & layer structure input from the input device 21 (S45). The processing performed here is processing of acquiring information of a print circuit board as an analysis object from the input CAD data & layer structure and generating an equivalent circuit model that is expressed by concentrated constants or distributed constants of the print circuit board based on the physical dimensions of a wiring pattern on the print circuit board, such as a microstrip line, for use in a circuit simulator such as Simulation Program with Integrated Circuit Emphasis (SPICE). The physical dimensions of a wiring pattern are, as illustrated in FIG. 5, an electrical constant of the resist 51, an electrical constant of the insulating layer 52, the linewidth 55 of a metal wiring 53, a layered structure comprising a ground 54 and the metal wiring 53, and the like.

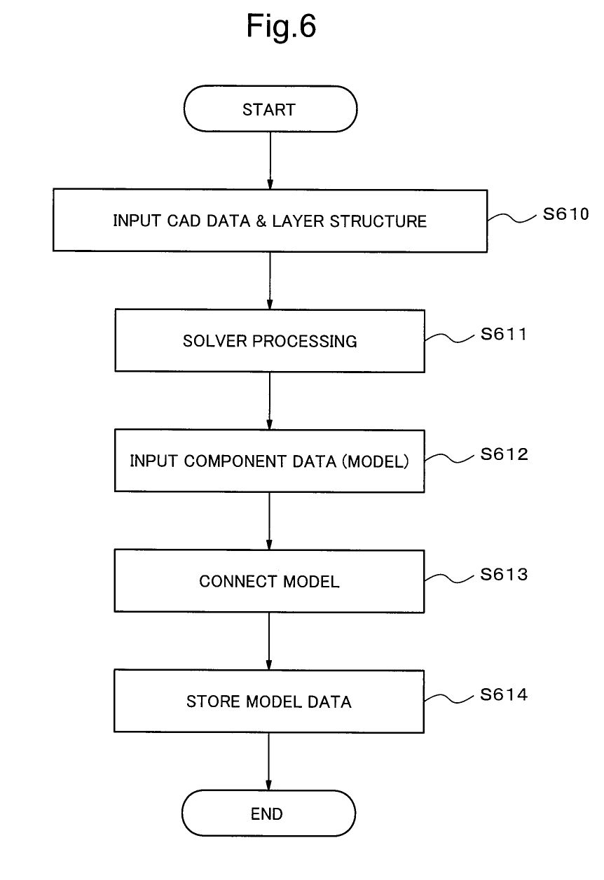

FIG. 6 is a flowchart illustrating a specific example of the processing of S45 as described in FIG. 4.

First, the input device 21 inputs the CAD data & layer structure illustrated in FIG. 5 to the board & PKG model generation unit 23 (S610).

Then, the board & PKG model generation unit 23 performs solver processing using means that is called as a field solver or the like (S611). The board & PKG model generation unit 23 can have thereinside a field solver that generates an equivalent circuit of a board and package. In particular, the solver processing is processing of, by giving an ideal physical shape and material constant of a wiring pattern, such as a microstrip line, converting the given ideal physical shape and material constant into an equivalent circuit that is described by concentrated constants or distributed constants per unit length expressed by resistance, inductance, capacitance, and conductance.

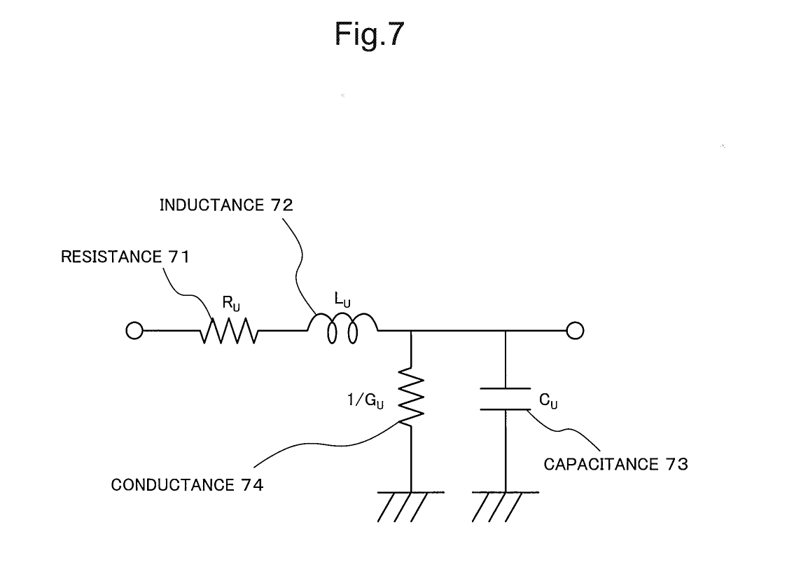

FIG. 7 is a diagram illustrating an example of an equivalent circuit model per unit length that is obtained by solver processing. The values of resistance 71, inductance 72, capacitance 73, and conductance 74 per unit length of wiring are respectively R_{U}, L_{U}, C_{U}, and G_{U}.

Next, the input device 21 inputs data of the components that are connected to the print circuit board to the board & PKG model generation unit 23 (S612). This processing will be described with the print circuit board of FIG. 11 as an example. More specifically, S612 is processing of inputting data of inactive components such as a filter circuit 115 and a terminating resistor 114 that are connected to the signal transmission path 113. For these components, an equivalent circuit in which these components are already prepared can be directly input instead of inputting each structure.

Next, the board & PKG model generation unit 23 connects the input component models (S613). In the case of the print circuit board of FIG. 11, the board & PKG model generation unit 23 connects the component models of the terminating resistor 114 and the filter circuit 115 to the equivalent circuit of the signal transmission path 113 that is generated by solver processing to generate the equivalent circuit of the board and package. Then, the model data generated in this way is stored in the storage device (S614).

Returning to FIG. 4, next, the model coupling unit 24 connects the simplified LSI model generated at S43 to the board & PKG model generated at S45 (S46). For example, a circuit simulation model can be generated by coupling in such a manner that the power supply side port of the simplified LSI model is connected to the power supply port of the LSI of the board & PKG model, the GND side port of the simplified LSI model is connected to the GND port of the LSI of the board & PKG model, and the signal side port of the simplified LSI model is connected to the signal port of the LSI of the board & PKG model.

Next, the operating unit 25 performs circuit analysis of the circuit simulation model generated at S46 (S47).

Next, the output device 26 outputs the analysis result of S47 (S48).

As the circuit simulation model generated in this way simulates the operation of an LSI by a change of the variable resistance, the model allows analysis in a short time and with higher accuracy for not only SI analysis but also PI analysis. Conventionally, in analysis using commonly available IBIS models, as an electric current is deemed as flowing in accordance with an I-V characteristics table with reference to the clock signal state without consideration of the influence of voltage fluctuation to signals and the influence of switching to voltage fluctuation, whereby cooperation analysis of SI analysis and PI analysis was not possible. Whereas, the embodiment reproduces electrical characteristics by a change of a variable resistance, which optimizes electric current that is driven by voltage and enables cooperation analysis of SI analysis and PI analysis.

The following will describe the accuracy of a simulation result of the embodiment. The following will describe, as an example, a print circuit board that has an LSI 111 and a signal transmission path 113 as illustrated in FIG. 11 where the power is supplied to the LSI 111.

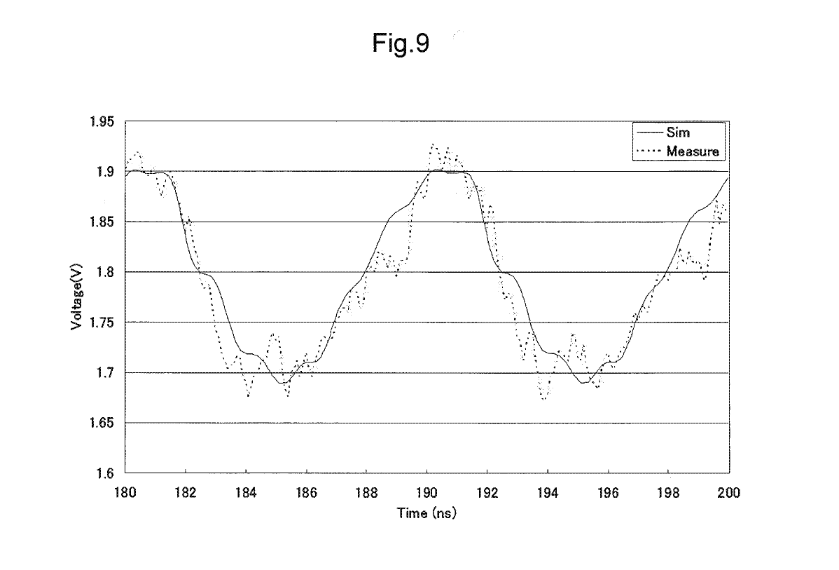

FIG. 9 illustrates voltage at the power supply port of the package 112 of the print circuit board of FIG. 11. The solid line of the simulation result approximates the dot line of the measured result with a difference that the measured result is superimposed by high frequency noise.

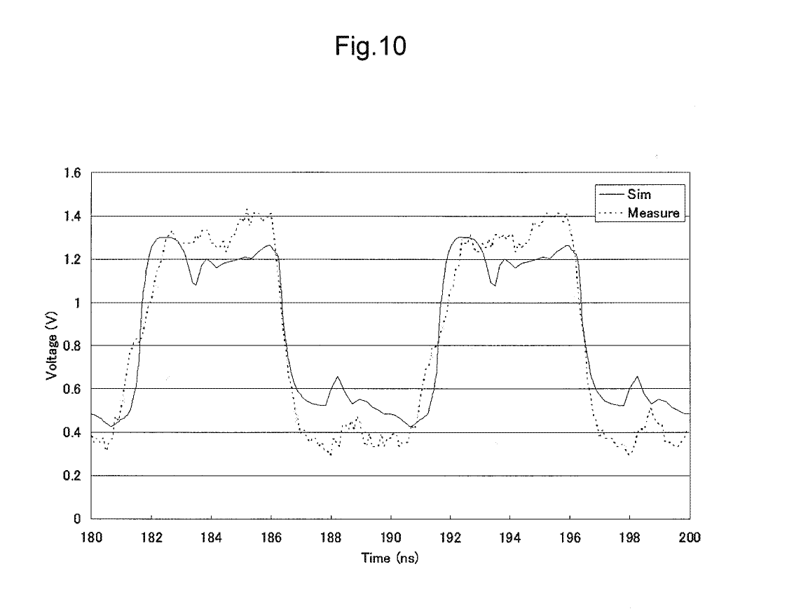

Next, FIG. 10 shows voltage in the signal transmission path 113 of the print circuit board of FIG. 11. While there are slight differences in the voltage values after steady voltage and rising characteristics, the solid line of the simulation result approximates the dot line of the measured result. As such, an analysis result that is close to the measured result with high accuracy can be obtained using the simplified LSI model generation function suggested in the embodiment.

The following will describe a variation of the embodiment.

The circuit simulation device of the embodiment may have a storage device that stores CAD information. Then, the input device 21 may automatically extract information that is required to generate an equivalent circuit of the board and package from the CAD information stored in the storage device and input the information to the board & PKG model generation unit 23. In this way, information input tasks of a system user can be simplified.

Further, the storage device may store a component database that includes equivalent circuits of passive components and an LSI model database that includes the I-V characteristics, V-T characteristics, and operating frequencies of semiconductor integrated devices. In such a case, the input device 21 extracts from the storage device predetermined information among the equivalent circuits of the passive components, the I-V characteristics, V-T characteristics, and the operating frequencies of the semiconductor integrated devices to input the information to predetermined portions of the simplified LSI model generation unit 22 and board & PKG model generation unit 23. In this way, information input tasks of a system user can be simplified.

As described above, by preparing the I-V characteristics, V-T characteristics, operating frequency, and operation pattern of a semiconductor integrated device in advance as input information in the storage device, even a person without abundant knowledge of LSIs and print circuit boards can easily generate a circuit simulation model. Further, as the circuit simulation model is a model that has relatively small circuit scale yet allows estimation of the power supply voltage fluctuation and transmission signals with accuracy, the model allows high speed calculation of the power supply voltage fluctuation and the waveforms of the transmission signals for confirming whether the operation is stable, enabling appropriate designing without over-margins.

Note that the I-V characteristics and V-T characteristics that are input by the input device 21 may be IBIS models.

In the present invention, the processing in the data processing device 20 can be implemented by special hardware, as well as, a program that causes the above-described respective steps to be executed as a circuit simulation model generation program. By storing the above described program in a recording medium that can be read by a general purpose computer, the circuit simulation model generation system can be implemented by a general purpose computer by executing the general purpose computer. Here, a readable recording medium refers to a portable recording medium such as a magneto-optical disk, a DVD, a CD, or the like, as well as a HDD embedded in the data processing device 20.

### <<Supplementary Note>>

According to the above description, the following inventions are explained.

### <Invention 1>

A circuit simulation device having:

an input device that inputs I-V characteristics, V-T characteristics, an operating frequency and an operation pattern of a semiconductor integrated device;

simplified LSI model generation means that generates a simplified LSI model of the semiconductor integrated device on the basis of contents of input from the input device; and

operating means that analyzes a circuit that includes the simplified LSI model.

### <Invention 2>

The circuit simulation device according to Invention 1,

wherein the simplified LSI model generation means generates a variable resistance from the I-V characteristics, as well as, generates a reference signal source from the V-T characteristics, the operating frequency and the operation pattern, and combines the variable resistance and the reference signal source to generate the simplified LSI model.

### <Invention 3>

The circuit simulation device according to Invention 1 or 2, further having:

board & PKG model generation means that generates an equivalent circuit of a board and package; and

model coupling means that couples the simplified LSI model and the equivalent circuit of the board and the package.

### <Invention 4>

The circuit simulation device according to Invention 3,

wherein the input device inputs information that is required for generating the equivalent circuit of the board and the package; and

the board & PKG model generation means generates the equivalent circuit of the board and the package on the basis of the contents of input from the input device.

### <Invention 5>

The circuit simulation device according to Invention 4, further having:

a storage device that stores CAD information,

wherein the input device automatically extracts information that is required for generating the equivalent circuit of the board and the package from the CAD information stored in the storage device to input the information.

### <Invention 6>

The circuit simulation device according to any one of Inventions 1 to 5, having:

a storage device that stores a component database that includes an equivalent circuit of passive components and an LSI database that includes the I-V characteristics, the V-T characteristics, and the operating frequency of the semiconductor integrated circuit,

wherein the input device extracts predetermined information from the storage device and inputs the information to predetermined means.

### <Invention 7>

The circuit simulation device according to any one of Inventions 3 to 5 and Invention 6 that depends on any one of Inventions 3 to 5,

wherein the board & PKG model generation means has a field solver thereinside that generates the equivalent circuit of the board and the package on the basis of an input from the input device.

### <Invention 8>

The circuit simulation device according to any one of Inventions 1 to 7,

wherein the I-V characteristics and the V-T characteristics that are input by the input device are IBIS models.

### <Invention 9>

A circuit simulation method that executes:

by a computer,

an input step that inputs I-V characteristics, V-T characteristics, an operating frequency and an operation pattern of a semiconductor integrated device;

a simplified LSI model generation step that generates a simplified LSI model of the semiconductor integrated device on the basis of contents of input in the input step; and

an operating step that analyzes a circuit that includes the simplified LSI model.

### <Invention 9-2>

The circuit simulation method according to Invention 9,

wherein the simplified LSI model generation step generates a variable resistance from the I-V characteristics, as well as, generates a reference signal source from the V-T characteristics, the operating frequency, and the operation pattern, and combines the variable resistance and the reference signal source to generate the simplified LSI model.

### <Invention 9-3>

The circuit simulation method according to Invention 9 or 9-2, further executing:

by the computer,

a board & PKG model generation step that generates an equivalent circuit of a board and package; and

a model coupling step that couples the simplified LSI model and the equivalent circuit of the board and the package.

### <Invention 9-4>

The circuit simulation method according to Invention 9-3,

wherein the input step inputs information that is required for generating the equivalent circuit of the board and the package; and

the board & PKG model generation step generates the equivalent circuit of the board and the package on the basis of the contents of input in the input step.

### <Invention 9-5>

The circuit simulation method according to Invention 9-4,

wherein the computer stores CAD information, and

the input step automatically extracts information that is required for generating the equivalent circuit of the board and the package from the CAD information to input the information.

### <Invention 9-6>

The circuit simulation method according to any one of Inventions 9 to 9-5,

wherein the computer stores a component database that includes an equivalent circuit of passive components and an LSI database that includes the I-V characteristics, the V-T characteristics, and the operating frequency of the semiconductor integrated circuit, and

the input step extracts predetermined information from the component database and the LSI database and inputs the information for use at a predetermined step.

### <Invention 9-7>

The circuit simulation method according to any one of Inventions 9-3 to 9-5 and Invention 9-6 that depends on any one of Inventions 9-3 to 9-5,

wherein the board & PKG model generation step performs solver processing using field solver processing that generates the equivalent circuit of the board and the package on the basis of an input in the input step.

### <Invention 9-8>

The circuit simulation method according to any one of Inventions 9 to 9-7,

wherein the I-V characteristics and the V-T characteristics that are input at the input step are IBIS models.

### <Invention 10>

A program that causes a computer to function as:

input means that inputs I-V characteristics, V-T characteristics, an operating frequency and an operation pattern of a semiconductor integrated device;

simplified LSI model generation means that generates a simplified LSI model of the semiconductor integrated device on the basis of contents of input from the input means; and

operating means that analyzes a circuit that includes the simplified LSI model.

### <Invention 10-2>

The program according to Invention 10,

wherein the simplified LSI model generation means generates a variable resistance from the I-V characteristics, as well as, generates a reference signal source from the V-T characteristics, the operating frequency, and the operation pattern, and combines the variable resistance and the reference signal source to generate the simplified LSI model.

### <Invention 10-3>

The program according to Invention 10 or 10-2, that causes the computer to further function as:

board & PKG model generation means that generates an equivalent circuit of a board and package; and

model coupling means that couples the simplified LSI model and the equivalent circuit of the board and the package.

### <Invention 10-4>

The program according to Invention 10-3,

wherein the input means inputs information that is required for generating the equivalent circuit of the board and the package; and

the board & PKG model generation means generates the equivalent circuit of the board and the package on the basis of the contents of input from the input means.

### <Invention 10-5>

The program according to Invention 10-4, that causes the computer to further function as:

storage means for storing CAD information,

wherein the input means automatically extracts information that is required for generating the equivalent circuit of the board and the package from the CAD information stored in the storage means to input the information.

### <Invention 10-6>

The program according to any one of Inventions 10 to 10-5, that causes the computer to function as:

storage means that stores a component database that includes an equivalent circuit of passive components and an LSI database that includes the I-V characteristics, the V-T characteristics, and the operating frequency of the semiconductor integrated circuit,

wherein the input means extracts predetermined information from the storage means and inputs the information to predetermined means.

### <Invention 10-7>

The program according to any one of Inventions 10-3 to 10-5 and Invention 10-6 that depends on any one of Inventions 10-3 to 10-5,

wherein the board & PKG model generation means has a field solver that generates the equivalent circuit of the board and the package on the basis of an input from the input means.

### <Invention 10-8>

The program according to any one of the inventions 10 to 10-7,

wherein the I-V characteristics and the V-T characteristics that are input by the input means are IBIS models.

This application is based upon and claims the benefit of priority from Japanese Patent Application No. 2012-229301, filed on Oct. 16, 2012, the disclosure of which application is incorporated herein in its entirety by reference.

What is claimed is:

1. A circuit simulation device comprising:
an input device that inputs I-V characteristics, V-T characteristics, an operating frequency, and an operation pattern of a semiconductor integrated device;
simplified LSI model generation unit that generates a simplified LSI model of the semiconductor integrated device on the basis of contents of input from the input device; and
operating unit that analyzes a circuit that includes the simplified LSI model.

2. The circuit simulation device according to claim 1,
wherein the simplified LSI model generation unit generates a variable resistance from the I-V characteristics, as well as, generates a reference signal source from the V-T characteristics, the operating frequency, and the operation pattern, and combines the variable resistance and the reference signal source to generate the simplified LSI model.

3. The circuit simulation device according to claim 1, further comprising:
board & PKG model generation unit that generates an equivalent circuit of a board and package;
model coupling unit that couples the simplified LSI model and the equivalent circuit of the board and the package.

4. The circuit simulation device according to claim 3,
wherein the input device inputs information that is required for generating the equivalent circuit of the board and the package; and
the board & PKG model generation unit generates the equivalent circuit of the board and the package on the basis of the contents of input from the input device.

5. The circuit simulation device according to claim 4, further comprising:
a storage device that stores CAD information,
wherein the input device automatically extracts information that is required for generating the equivalent circuit of the board and the package from the CAD information stored in the storage device to input the information.

6. The circuit simulation device according to claim 1, comprising:
a storage device that stores a component database that includes an equivalent circuit of passive components and an LSI database that includes the I-V characteristics, the V-T characteristics, and the operating frequency of the semiconductor integrated circuit,
wherein the input device extracts predetermined information from the storage device and inputs the information to predetermined means.

7. The circuit simulation device according to claim 3,
wherein the board & PKG model generation unit comprises thereinside a field solver that generates the equivalent circuit of the board and the package on the basis of an input from the input device.

8. The circuit simulation device according to claim 1,
wherein the I-V characteristics and the V-T characteristics that are input by the input device are IBIS models.

9. A circuit simulation method comprising:
inputting I-V characteristics, V-T characteristics, an operating frequency, and an operation pattern of a semiconductor integrated device;
generating a simplified LSI model of the semiconductor integrated device on the basis of contents of input in the input step; and
analyzing a circuit that includes the simplified LSI model.

10. A non-transitory computer readable medium storing a program that causes a computer to perform a circuit simulation method, the method comprising:
inputting I-V characteristics, V-T characteristics, an operating frequency, and an operation pattern of a semiconductor integrated device;
generating a simplified LSI model of the semiconductor integrated device on the basis of contents of input from the input means; and
analyzing a circuit that includes the simplified LSI model.
